(19) United States
(12) Patent Application Publication
(10) Pub. No.: US 2019/0249779 A1
(43) Pub. Date: Aug. 15, 2019

(54) Tank Valve

(71) Applicant: Daimler AG, Stuttgart (DE)

(72) Inventors: Simone ALBERT, Neidlingen (DE); Fabian GALL, Albstadt (DE); Philipp HAUSMANN, Kirchheim (DE); Alessandro LONATI, Botticino (BS) (IT); Renato SANTULLI, Brescia (BS) (IT)

(73) Assignee: Daimler AG, Stuttgart (DE)

(21) Appl. No.: 16/314,054

(22) PCT Filed: Jun. 7, 2017
(86) PCT No.: PCT/EP2017/000657

§ 371 Date: Dec. 28, 2018

(30) Foreign Application Priority Data
Jul. 1, 2016 (DE) 10 2016 008 058.2

(51) Int. Cl. F16K 1/30; F16K 15/02; F16K 25/00; F17C 13/04

(52) U.S. Cl. CPC F16K 1/305; F16K 15/02; F16K 25/005; F17C 13/04; F17C 2223/036; F17C 2205/0385; F17C 2221/012; F17C 2223/0123; F17C 2270/0168; F17C 2205/0335

(57) ABSTRACT

The invention relates to a tank valve (4) for mounting on a pressurized-gas container (3), having a main body (5), having multiple functional subassemblies for the refilling of the pressurized-gas accumulator (3), for the removal of gas from the pressurized-gas accumulator (3) and the implementation of safety and operating functions, wherein one of the functional subassemblies is formed as an extraction valve (6), and wherein at least one of the other functional subassemblies is formed as a check valve (14, 17). The tank valve according to the invention is characterized in that both the extraction valve (6) and the at least one check valve (14, 17) have in each case one valve seat carrier (22) with a valve seat (21) and one valve body (19), wherein that part of the valve seat carrier (22) which interacts with the valve body (19) has a sealing lip (23), which projects in an axial direction, as part of the valve seat (21).

The invention relates to a tank valve of the kind further defined in the preamble of claim 1. The invention also relates to the use of a tank valve of this kind.

A tank valve for mounting on a pressurized gas container is known from the general state of the art. Such a tank valve is frequently referred to by the English term on-tank-valve or by its abbreviation OTV. The tank valve in this case is a structure having a main body, which includes so-called functional subassemblies that are necessary for implementing the functionality of the tank valve. Such functional subassemblies may, for example, comprise an extraction valve, a check valve, a safety valve, a (manual) shut-off valve, a filter, a gas connection for a refilling and/or an extraction or the like.

Reference is made with respect to such tank valves to JP 2009-168165A, for example, which shows such a tank valve referred to as a high pressure valve. Other valves are known, for example, from US 2009/0146094 A1 or, in the form of a pilot valve, also from EP 1 682 801 B1.

The disadvantage of such arrangements is that on the one hand a seal, in particular, in the area of the pilot valves in the form of extraction valves and in the area of check valves, requires a comparatively high pressure difference in order to operate reliably. This applies, in particular, when storing hydrogen, which is known to be slightly volatile. A further disadvantage is that the costs for such tank valves are comparatively high, since a very large number of different, in part very complex-shaped components is required inside such a tank valve.

Also known from the further general state of the art in the form of U.S. Pat. No. 8,087,642 B2 is a refilling valve for a carbon dioxide storage device. In one embodiment variant of the refilling valve, a sealing lip may be provided, which is designed as part of a valve seat or valve body in order to improve the seal.

The object of the present invention is to specify a very simple and cost-effective tank valve, which functions very reliably in terms of sealing.

According to the invention. this object is achieved by a tank valve having the features of the characterizing portion of Claim 1. Advantageous embodiment and refinements arise from the sub-claims dependent therefrom. Moreover, a particularly preferred use of such a tank valve is specified in Claim 10.

The tank valve according to the invention includes an extraction valve and at least one check valve, as is already known from the general state of the art. According to the invention, it is provided that both the extraction valve as well as the at least one check valve each include a valve seat carrier having a valve seat and a valve body. The part of the valve seat carrier interacting with the valve body includes in this case a sealing lip as part of the valve seat, which protrudes in an axial direction. Such a sealing lip protrudes above the material of the valve seat carrier in an axial direction and ensures a high elasticity of the valve seat in the area of this sealing lip. A solid contact of the valve seat on the valve body and, therefore, an excellent seal is achieved as a result. An excellent seal may also be achieved in the case of slightly volatile gases such as, for example, hydrogen, as a result of the elasticity achieved by the sealing lip and the resultant improved seal. This applies both in the area of the extraction valve as well as in the area of the check valves. An excellent seal may also be achieved in this case, in particular, in the case of a comparatively minimal pressure difference between the one side and the other, which frequently occurs during cyclical operation in extraction valves, which may be designed, in particular, as pilot valves, and which is occasionally also the case in check valves during operation.

The valve bodies and/or the valve seat may be designed here as a spherical component on the one hand and as a spherical calotte on the other hand. The combination between a spherical component and a conical valve seat is also conceivable. A particularly solid seal may however be achieved, in particular, if in a very favorable embodiment of the concept, the part of the extraction piston utilized as the valve body is conical and the conical valve body interacts with a conical valve seat, wherein the opening angle of the cone of the valve body and of the valve seat differ from one another. Such a conical valve body may then ideally interact with the conical valve seat. Conical in the sense of the present invention is understood to mean a shape, which is also referred to as the outside surface of a truncated cone. In this case, conical in the sense of the invention comprises not only the outer surface of a single truncated cone, but may also comprise multiple directly adjoining outside surfaces of different truncated cones having different opening angles. The truncated cone, which defines the shape, may therefore include multiple axial sections of different opening angles. Such a truncated cone ensures an excellent seal, especially if, in accordance with this concept, the conical valve body has a smaller or larger opening angle of the truncated cone in the area of its contact with the conical valve seat, than the valve seat. This difference in the varying opening angles of the truncated cones of the two conical interacting elements, valve body and valve seat, ensures a largely linear, circumferential contact of the valve body on the valve seat. A correspondingly high surface contact pressure is achieved as a result, ensuring an excellent seal, which ensures a decisive advantage in terms of tightness, in particular, in the case of hydrogen.

According to one very favorable embodiment of the tank valve according to the invention, it may be provided that the valve seat carriers in the extraction valve and in all check valves are the same components. By designing the valve seat carriers with the sealing lip in the form of identical parts for all check valves and for the extraction valve inside the main body of the tank valve, it is possible to increase the number of similar components. In this way, each one of these components becomes more cost-effective by way of a scale effect, so that the tank valve overall may also be correspondingly more cost-effectively designed.

According to another very favorable embodiment of the tank valve according to the invention, it may also be provided that the valve seat carrier is secured in the main body in a twist-proof manner, and that a valve body carrier that carries or includes the valve body is designed to be twist-proof relative to the valve seat carrier via at least one guide element. This design, which may be implemented, for example, via a guide pin or via a non-rotationally symmetrical shape of the valve body carrier and a guide opening for the latter, prevents the valve seat and the valve body from twisting relative to one another during operation. During operation, the valve opens and closes, so that in the opened position, the valve seat is lifted from the valve body and in the closed position, the valve body abuts the valve seat. Increasing operation and increasing opening and closing cycles therefore result in any case in an—at least marginal—mechanical adaptation of the surfaces of both components to one another. Minimal deformations in the valve body and/or in the valve seat then ensure an even better contact of the surfaces of these two components with one another, and therefore enhance the sealing effect. Thus, the tightness may ultimately be increased by preventing the components from rotating relative to one another during operation.

According to one very advantageous refinement of the tank valve, it may be provided when using a sealing lip, that an activation volume is situated around the sealing lip, which is in contact with the pressurized gas present on the valve body and on the valve seat in the closed position. Such an activation volume on the side of the sealing lip of the valve seat facing away from the valve body in the closed position means that the comparatively elastic sealing lip is pushed in the direction of the valve body by the pressure of the gas subject to excess pressure present in the area of this activation volume. Thus, the pressure of the gas subject to excess pressure helps to press the sealing lip preferably firmly and sealingly against the valve body. Thus, the gas itself aids in improving the seal, which is why this is referred to as pressure activation.

According to one particularly favorable embodiment of the concept, the extraction valve may be designed as an electromagnetically actuated pilot valve, wherein the valve seat carrier with the valve seat and the valve body form the main seal of the pilot valve. Such an embodiment of the extraction valve of the pilot valve is known, in principle, in high pressure gas storage tanks, for example, for storing hydrogen or compressed natural gas. Such a pilot valve is typically electromagnetically controlled and is self-supported by the pressure of the gas after an initial activation, so that a very reliable and well-functioning dosing is possible via such a pilot valve. This pilot valve may now have the valve seat with the sealing lip in the area of its main seal, and may thus ensure an excellent seal also in terms of the sealing of critical gases such as, for example, hydrogen.

According to one advantageous refinement of the tank valve, it may also be provided that the at least one check valve is designed as a check valve in a refilling line and/or as a check valve in an extraction line. Check valves are frequently utilized in the area of the tank valves. A check valve is, in particular, generally known and commonplace in the area of a refilling line. It is utilized there in such a way that it is pushed open by the gas flowing into the pressurized gas container during refilling and, when the refilling is completed, is reliably closed by the pressure prevailing in the interior of the pressurized gas container. An embodiment of the seal having a sealing lip may thus always ensure here a reliable seal of the refilling path, in particular, when no refilling is taking place.

Alternatively or in addition, the check valve may also be formed in the extraction line. In practice, it is the case that an extraction valve, in particular, if it is designed as a pilot valve, does not close, or does not always reliably close in the case of high differential pressures, which act counter to its usual flow-through direction. Thus, a check valve may be situated in the extraction line in order to prevent an inflow of the gas through the extraction valve. This check valve is situated in such a way that it is opened in the event gas is extracted and is correspondingly closed in the event of refilling, in order to prevent a flow-through of the extraction line during refilling. Here, too, a good seal is a factor, such that the use of a seal having a sealing lip in the sense described above is advantageous for this check valve as well.

According to one particularly advantageous refinement of the tank valve according to the invention, the valve seat carrier and/or the valve body may be made of a high-performance plastic, in particular, a high-performance thermoplastic. This use of a high-performance plastic such as, for example, PEEK (polyether ether ketone), PI (polyimide), PAI (polyamide-imides) or of another high-performance plastic, is particularly advantageous. These high-performance plastics have a glass transition temperature and melting temperature that lie above the temperatures normally occurring during operation. Thus, a material property is uniform and homogenous over the entire temperature range in which the extraction valve is operated. In terms of mechanical form stability, the high-performance plastics also exhibit a certain residual elasticity, in particular, of approximately 3%. This is sufficient to ensure an excellent sealing contact between the valve seat and the valve body. In this case, the plastics may be very easily processed in the desired manner. The processing may take place in the form, for example, of injection compression or sintering, in particular, including a mechanical post-processing in the area of the undercut of the sealing lip that forms the activation volume. They also exhibit excellent glide properties, a high wear resistance and excellent mechanical properties. Thus, they are ideally suited for forming the valve seat and/or the valve body according to the invention. The valve seat, in particular, which is integrally formed with the sealing lip, ensures a very simple and efficient design through the use of such high-performance plastics. The valve seat with its sealing lip may, for example, be produced from PEEK or PI. In this case, it would ideally interact with a valve seat integrally attached to the extraction piston which, in turn, is produced from the material of the extraction piston, for example, from a steel material such as, in particular, 1.4016IM, 1.4435 or SUSF316L or also from one of the aforementioned high-performance plastics.

The decisive advantage of the tank valve according to the invention is the reliable functionality and the reduced production costs. These advantages have an impact, in particular, in vehicle applications involving high unit volumes. For this reason, a use of the tank valve according to Claim 10 is provided on a pressurized gas container for storing hydrogen or natural gas and, here in particular, at a nominal pressure of more than 65 MPa, as fuel in a vehicle.

Additional advantageous embodiments of the tank valve according to the invention, and its use also arise from the additional dependent sub-claims and from the exemplary embodiment, which is described in greater detail below with reference to the figures.

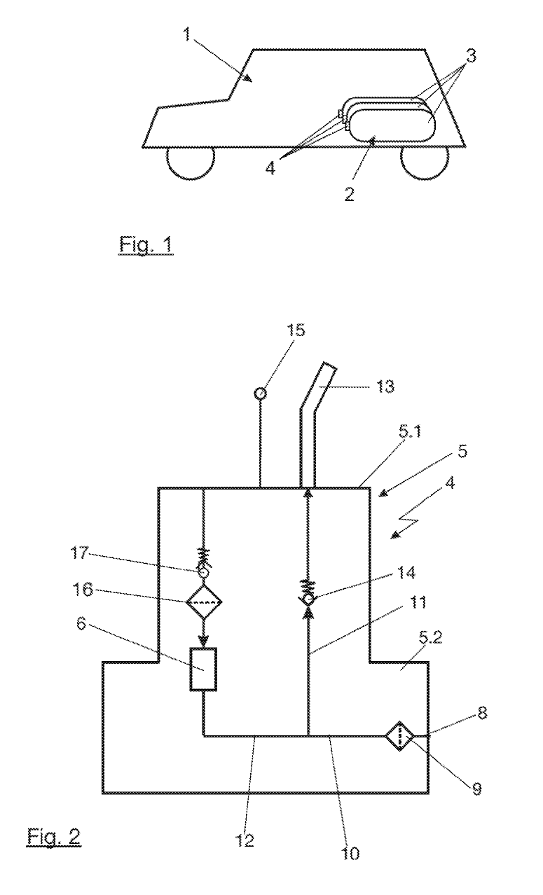

FIG. 1 shows a vehicle illustrated in principle having a storage system for pressurized gas as fuel;

FIG. 2 schematically shows an illustration of a possible tank valve according to the invention in a pneumatic flow diagram;

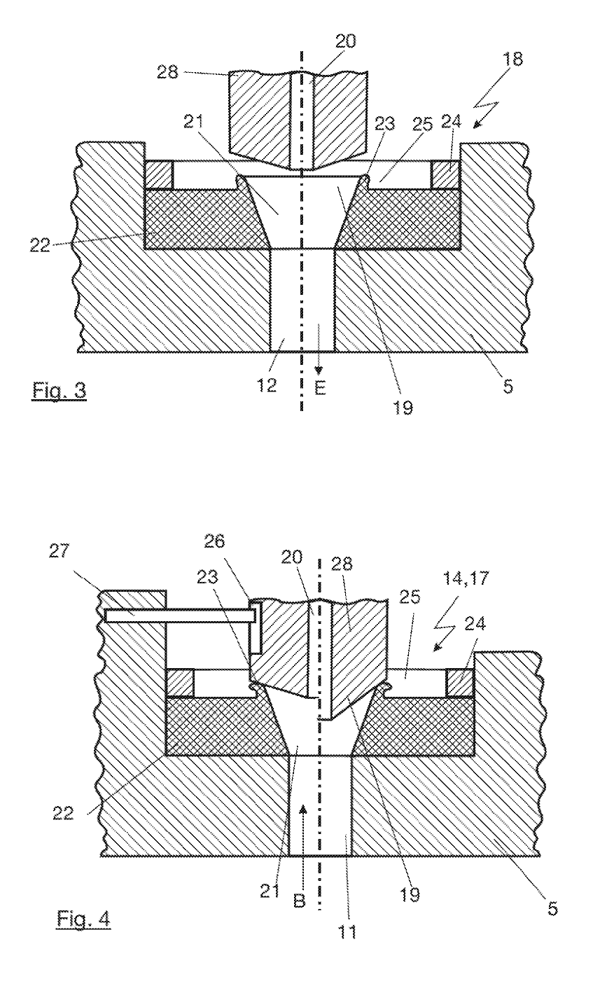

FIG. 3 shows in principle a sectional view, not to scale, through the sealing area of a pilot valve in the opened position; and

FIG. 4 shows in principle a sectional view, not to scale, through the sealing area of a check valve in the closed position.

A vehicle 1 is indicated purely by way of example in the illustration of FIG. 1. This vehicle is intended to be driven using a gaseous fuel, for example, using compressed natural gas or compressed hydrogen. For this purpose, the fuel may be converted in an internal combustion engine or, in particular, when using hydrogen, preferably also in a fuel cell system in the capacity utilized for the drive, A storage device identified in its entirety by reference numeral 2 is present in the vehicle 1 for storing the pressurized gas. The storage device consists of multiple individual pressurized gas containers 3, each of which carries a tank valve 4. This tank valve 4 is also referred to as an on-tank-valve or abbreviated as OTV. In this case, the individual pressurized gas containers 3 together with their tank valves 4 may be connected to one another via a shared line, as is known, for example, from the prior art mentioned at the outset, so that gas from the storage device 2 may be utilized in the vehicle. The nominal pressure in such pressurized gas containers 3 with their tank valves 4 in this case is typically on the magnitude of 70 MPa, in particular when storing hydrogen, for example, for the preferred application in a fuel cell system. In addition to safety requirements for the individual pressurized gas containers 3 and their tank valves 4, stringent requirements in terms of tightness must also be imposed, but also in terms of the possibility of producing these safely, reliably and cost-effectively.

A schematic illustration of a tank valve 4 is apparent in the illustration of FIG. 2. The tank valve 4 in this case comprises a main body 5, which consists essentially of two sections. A first main body section 5.1 is designed in such a way that it protrudes into the respective pressurized gas containers in the later mounted state of the tank valve 4. For this purpose, it includes a thread not shown in the exemplary embodiment depicted herein, which interacts with a corresponding thread in a receiving element of the pressurized gas container 3 not shown herein. A second main body section 5.2 is apparent in the lower area of the tank valve 4 in the illustration of FIG. 2. This second main body section 5.2 is located outside the pressurized gas container 3 once the tank valve 4 is mounted. The second main body section 5.2 in this case includes multiple so-called functional sub-assemblies of the tank valve 4. The functional sub-assemblies in the second main body section 5.2 in this case comprise an electromagnetically actuated pilot valve 6 as extraction valve 6 for extracting gas from the pressurized gas container 3. It is actuated via an electromagnetic coil identified by reference numeral 7. In terms of the functionality of such a pilot valve, reference may be made, for example, to the statements in DE 10 2013 019 978 A1 of the applicant.

Additional functional subassemblies integrated in the second main body 5 are apparent in the illustration of FIG. 2. These may comprise various functionalities. Some of these are explained below, though the functional sub-assemblies are not shown in the figure. However, they are familiar to the person skilled in the art, so that a detailed explanation may be dispensed with. These functional sub-assemblies, not shown, but which may be present in the tank valve 4, may comprise a manual shut-off valve, for example. A thermally triggering safety valve could also be present as an additional functional group. Such thermally triggering safety valves are known, in principal, from the general state of the art. In one conventional embodiment, a screw is used here, which has a central bore. Located in the central bore is a plumb or a barrier element held fast via a plumb. If the area of the tank valve 4 or of the thermally triggering safety valve is heated to above the melting temperature of the plumb, then the through-bore in the screw is unblocked and the gas that is in constant contact with the screw in the interior of the pressurized gas container is able to flow out. An alternative to this, which is used very frequently, in particular, in the European and American market, consists of a design, in which a valve body is held in position by a glass ampule with a low boiling liquid. The boiling point of the liquid in the glass ampule is gauged so that the liquid begins to boil at a critical temperature of the thermally triggering safety valve. The glass ampule is destroyed during boiling as a result of the increase in volume and the valve body is unblocked relative to the valve seat, As a result of the pressure of the gas in the pressurized gas container, which is queued next to the valve body, the pressurized gas container is moved into an opened position, away from the valve seat, so that the gas is able to flow out of the pressurized gas container 3.

A gas connection 8 is apparent in the illustration of FIG. 2 as an additional functional sub-assembly in the area of the second main body 5. This gas connection serves to extract gas from the pressurized gas container via the pilot valve 6 and to refill the pressurized gas container 3. A first filter 9 may be integrated in the gas connection 8. For the purpose of refilling and of removing gas, the tank valve 4 may be connected via the gas connection 8 to a line system, which connects the pressurized gas container 3 fitted with the tank valve 4 to a refilling line and to a consumer and/or to additional pressurized gas containers 3 of the storage device 2.

The gas connection 8 is continued further in the main body 5 via a line section 10 and then branches into a refilling line 11 and an extraction line 12. Both lines in this case have the same through-flowable cross section. This makes it especially easy to, in particular, manufacture the lines 11, 12 that are typically drilled in the main body 5. The refilling line 11 leads to a pipe section 13 and includes a check valve 14. This check valve 14 is pushed open against the force of a spring during the refilling process, so that during refilling the gas is able to flow via the pipe section 13 into the pressurized gas container 3. In the process, the inflow is directed through the slightly curved or slightly kinked tube section 13 past a temperature sensor 15, so that this temperature sensor measures the temperature of the gas mixture forming in the pressurized gas container 3 and not the temperature of the directly inflowing gas.

The extraction line 12 also extends through the main body 5 and includes a filter 16. The extraction line 12 includes as the extraction valve 6 the pilot valve 6, which functions in the manner cited in the aforementioned German application. In addition, a further check valve 17 is provided in the extraction line 12. It is normally easily opened by a spring. It is pushed opened during extraction by the gas flowing toward the pilot valve 6, assisted by the spring, so that an extraction is easily possible. During refilling, it is the case that the pilot valve 6 would admit gas at higher pressure differentials. To prevent a flow-through of the pilot valve 6, the check valve 17 is therefore designed so that it blocks the extraction line 12 against the force of the spring in the flow direction during the refilling of the pressurized gas container 3. As a result, the pilot valve 6 is protected on the one hand and, on the other hand, gas is prevented from exiting directly in the vicinity of the temperature sensor 15 and thereby distorting in an undesirable manner the measured temperature of the gas located in the pressurized gas container 3.

Both the extraction valve 6 as well as the two check valves 14, 17 in the tank valve 4 now include a valve body on the one hand and a valve seat on the other hand. These components are not further numbered in the schematic illustration of FIG. 2. A schematic illustration of a so-called main seal 18 of the extraction valve, respectively, pilot valve 6 is apparent in the illustration of FIG. 3. The main seal 18 consists of a valve body 19 on the one hand, which is indicated herein as valve body carrier 26 of the pilot valve 6 as part of or as the tip of a so-called extraction piston. The valve body 19 includes a bore in the center identified by reference numeral 20, which leads to the so-called pilot opening at the other end of the extraction piston. The functionality need not be further discussed, it may be found in detail, for example, in the aforementioned application of the applicant on the pilot valve. Nor is it of further relevance for the present application. The valve body 19 then interacts with a valve seat 21. In this case, the main seal 18 is shown in the opened position in the illustration of FIG. 3. In the closed position, the valve body 19 and the valve seat 21 would touch accordingly. The valve seat 21 in this case is formed in a valve seat carrier 22, which is introduced, for example, pressed in, in a sealing and twist-proof manner. A sealing lip 23, which protrudes above the main body of the valve seat carrier 22 in the direction of the valve body 19, is located in the area in which the valve body 19 abuts the valve seat 21 in the closed position.

Conical in the sense of the present invention here is understood to mean, as previously explained at the outset, a truncated cone outer surface, or also two or multiple truncated cone outer surfaces directly adjoining one another—optionally rounded in transition, which have different opening angles. The valve body 19 is also conically shaped in the sense of the present application here. As an alternative, a slightly rounded cone or a conical element having a correspondingly large radius would also be conceivable. The angles of the cone or, in the case of an excessively conical element, of the tangent in the area of contact between the valve seat 21 and the valve body 19 are in this case not identical, but differ from one another. The valve body 19 in this case preferably has a smaller opening angle tangential to the area of contact (for example, 90°), than the cone forming the valve seat (19) (for example, 100°). This ensures a linear contact of the valve body 19 on the valve seat 21, which enables a very high surface pressing and, therefore, an excellent seal. This design is shown to the left of the center line in the illustration of FIG. 4. In contrast, a design is shown on the left side of FIG. 4, in which the cone that forms the valve seat 19 has the same angle tangential to the area of contact as on the right side, whereas the valve body 28 is intended to have a larger angle of, for example, approximately 110°.

The valve seat carrier 22 in this case is preferably produced from a high-performance plastic, for example, PEEK, PI or PAI. The entire extraction piston or at least the area that forms the valve body 19 may, for example, be formed from a steel material or preferably also from an equivalent high-performance plastic. These high-performance plastics in this case have the advantage that they have a glass transition temperature above the usual temperatures occurring during operation. Thus, a material property is uniform and homogenous over the entire temperature range in which the tank valve 4 is operated. Moreover, these high-performance plastics exhibit a certain residual elasticity in terms of mechanical form stability, in particular, of approximately 3%. This is sufficient to ensure an excellent sealing contact between the valve seat 21 and the valve body 19. This enables the main valve seat of the extraction valve 4 to be well sealed, in particular, also in the case of very high nominal pressures and slightly volatile gases such as, for example, hydrogen at a nominal pressure of 70 MPa which, in practice, may result in pressures typically between 10 MPa and 105 MPa.

The valve seat 21 in the embodiment illustrated here also includes a sealing lip 23. This sealing lip 23 is formed so that it protrudes above the material of the valve seat carrier 22 in the direction of the extraction piston. An empty space remains between the sealing lip 23 and a retainer ring 24 which, for example, serves to securely fix the valve seat carrier 22 relative to the main body 5. In the closed position, this space is in contact with the gas pressurized by the main seal 18. It forms an activation volume 25. The pressurized gas in the activation volume 25 therefore helps to push the sealing lip 23 in the direction of the valve body 19 and thereby improves the seal. This is also referred to as pressure activation.

For purposes of clarifying the flow direction during extraction, the primary flow direction of the gas during extraction is shown in the illustration of FIG. 3 with the arrow identified by E.

The structure in one or in both of the check valves 14, 17 comparable to the main seal is found in the illustration of FIG. 4, similar to the illustration in FIG. 3 but this time in the closed position. To the right of the center line is the structure of the valve body 28 having an opening angle smaller than the angle of the valve seat 21, left of the center line is a larger angle of the valve body with the correspondingly identical angle of the valve seat. In this case, the valve seat carrier 22 with the valve seat 21 is identically constructed and also includes the sealing lip 23. It is connected to the main body 5 in a twist-proof manner, for example, pressed and/or appropriately retained by the retainer ring 24. The only difference lies in the valve body 19, which in this case is not the part of an extraction piston and therefore does not include the bore 20. Otherwise, the functionality is essentially the same. During refilling, the gas is fed in accordance with the flow direction B, in this case through the refilling line 11, and pushes the valve body 19 into its opened position. Pressure no longer exists in the refilling line 11 once refilling is completed, so that the valve body 19 is pushed into the closed position shown herein by the interior pressure in the pressurized gas container 3. Thus, the pressure in this case is located above the valve seat carrier 22. An expansion of the pressure into the activation volume 25 occurs here as well, so that the same functionality as with the main seal 18 is achieved. The valve seat carrier 22 is designed in both applications as an interchangeable part and, correspondingly, may therefore be produced more cost-effectively due to the large number of parts required inside the tank valve 4.

Also shown purely by way of example, and exemplarily in the illustration of FIG. 4 is an anti-twist means intended to prevent a twisting of the valve body 19 relative to the valve seat carrier 22. For this purpose, a groove 26, for example, is introduced in the valve body 19 containing the valve body carrier 28. Thus, a movement in the axial direction, i.e. upward and downward in the illustration of FIG. 4, is readily possible by way of a pin 27, which is held, for example, pressed into main body 5, which corresponds to the groove 26. A twisting, however, is prevented by an anti-twist means in the form of the pin 27 and the groove 26. Alternative embodiments such as, for example, a positive-locking mounting of a guide element or the like are also conceivable.

1. A tank valve (4) for mounting on a pressurized gas container (3), having a main body (5) with multiple functional sub-assemblies for refilling the pressurized gas accumulator (3), for extracting gas from the pressurized gas accumulator (3), as well as for implementing safety and operating functions, wherein one of the functional sub-assemblies is designed as an extraction valve (6), and wherein at least one other of the functional sub-assemblies is designed as a check valve (14, 17),
characterized in that
both the extraction valve (6) and the at least one check valve (14, 17) each includes a valve seat carrier (22) having a valve seat (21) and a valve body (19), wherein the part of the valve seat carrier (22) interacting with the valve body (19) includes a sealing lip (23) as part of the valve seat (21), which protrudes in the axial direction.

2. The tank valve (4) according to claim 1,
characterized in that
the valve body (19) and the valve seat (21) are conically designed, wherein the opening angles of the cone of the valve body (19) and of the valve seat (21) differ from one another.

3. The tank valve (4) according to claim 1 or 2,
characterized in that
the valve seat carrier (22) in the extraction valve (9) and in all check valves (14, 17) are the same components.

4. The tank valve (4) according to claim 1, 2 or 3,
characterized in that
each of the valve seat carriers (22) is fastened in the main body (5) in a twist-proof manner, and that a valve body carrier (28) that includes the valve body (19) is designed to be twist-proof relative to the valve seat carrier (22) via at least one guide element (26, 27),

5. The tank valve (4) according to one of claims 1 through 4,
characterized in that
an activation volume (25) is situated around the sealing lip (23), which is in contact with the pressurized gas present on the valve body (19) and valve seat (21) in the closed position.

6. The tank valve (4) according to one of claims 1 through 5,
characterized in that
the extraction valve (6) is designed as an electromagnetically actuatable pilot valve (6), wherein the valve seat carrier (22), together with the valve seat (21) and the valve body (19), form a main seal (18) of the pilot valve.

7. The tank valve (4) according to one of claims 1 through 6,
characterized in that
the at least one check valve (14, 17) is designed as a check valve (14) in a refilling line (11) and/or as a check valve (17) in an extraction line (12).

8. The tank valve (4) according to one of claims 1 through 7,
characterized in that
the valve seat carrier (22) and/or the valve body (19) is/are formed from a high-performance plastic.

9. A use of a tank valve (4) according to one of claims 1 through 8, on a pressurized gas container (3) for storing hydrogen or natural gas, in particular, at a nominal pressure of more than 65 MPa, as fuel in a vehicle (1).
